(19) United States
(12) Patent Application Publication
(10) Pub. No.: US 2024/0117189 A1
(43) Pub. Date: Apr. 11, 2024

(54) METHOD FOR PRODUCING ASPHALT EMULSION

(71) Applicant: KAO CORPORATION, Tokyo (JP)

(72) Inventor: Hiroki KAKIUCHI, Wakayama-shi, Wakayama (JP)

(73) Assignee: KAO CORPORATION, Tokyo (JP)

(21) Appl. No.: 18/273,093

(22) PCT Filed: Jan. 21, 2022
(86) PCT No.: PCT/JP2022/002184

§ 371 Date: Jul. 19, 2023

(30) Foreign Application Priority Data
Jan. 21, 2021 (JP) 2021-008106

(51) Int. Cl. C08L 95/00

(52) U.S. Cl. CPC C08L 95/005; C08L 2555/80

(57) ABSTRACT

The present invention relates to [1] a method for producing an asphalt emulsion, the method including a step 1: a step of melt-mixing an asphalt and a polyester to obtain an asphalt mixture, and a step 2: a step of adding an aqueous medium and a surfactant to the asphalt mixture obtained in the step 1, followed by mixing, [2] an asphalt emulsion containing composite particles, the composite particles containing an asphalt and a polyester and having a volume median particle diameter (D₅₀) of 1 μm or more and 40 μm or less, [3] an asphalt mix for pavement, containing the asphalt emulsion of the above [2] and an aggregate, and [4] a method for paving a road, the method including a step of laying the asphalt mix for pavement of the above [3] onto a road at 150° C. or lower.

### FIELD OF THE INVENTION

The present invention relates to a method for producing an asphalt emulsion, an asphalt emulsion, an asphalt mix for pavement, and a method for paving a road.

### BACKGROUND OF THE INVENTION

Asphalt pavement using an asphalt mixture has been performed for paving driveways, parking spaces, cargo yards, sidewalks, etc. because of relatively easy construction and a short period of time from beginning of paving works to traffic start. Since performance in durability and the like is required for asphalt pavement, it is proposed to modify an asphalt with a polyester to increase the performance of asphalt pavement.

Asphalt has a high viscosity at normal temperature, resulting in poor workability. Thus, for ensuring a desired workability at normal temperature without heat, an asphalt emulsion in which an asphalt is dispersed in water to reduce the apparent viscosity is used.

PTL 1 (JP H09-59354 A) discloses, as an additive for asphalt emulsion and an asphalt composition that can develop a strength equal to or higher than that of a heating-type asphalt, can further increase waterproofness, and can also control the strength developing rate, an additive for asphalt emulsion, the additive containing a specific binder and a specific hardener composition, and an asphalt composition that contains the additive for asphalt emulsion and an asphalt emulsion.

Furthermore, various asphalt-free compositions that can achieve pavement at normal temperature are proposed.

PTL 2 (JP 2005-126998M discloses, as a composition for paving a road which has a sufficient strength, rapidly exhibits a strength, and can form or repair a paved body in an efficient manner, a composition for paving a road, the composition containing an aqueous dispersion in which a resin (A) having a specific acid value is neutralized with a basic compound and a silane coupling agent having a specific structure, and forming a binder material for an aggregate or a surface layer of a paved body in road pavement.

### SUMMARY OF THE INVENTION

The present invention relates to a method for producing an asphalt emulsion, the method including the following step 1 and step 2:

step 1: a step of melt-mixing an asphalt and a polyester to obtain an asphalt mixture;

step 2: a step of adding an aqueous medium and a surfactant to the asphalt mixture obtained in the step 1, followed by mixing.

### DETAILED DESCRIPTION OF THE INVENTION

Asphalt pavement has a problem of advanced degradation due to ultraviolet rays in long-term exposure to sunlight, resulting in cracking. This problem is particularly serious in a region subjected to high-intensity sunlight. When asphalt pavement is degraded, repair of the pavement becomes necessary. Repair of the pavement has resulted in increased maintenance costs and significant influence on car traffic. Thus, asphalt pavement superior in weather resistance which undergoes small degradation by ultraviolet rays is required.

In particular, from the viewpoint of energy saving, easy laying, and the like, it is required that asphalt pavement superior in weather resistance can be laid through normal-temperature pavement. However, in the case of the normal-temperature pavement, the water content is high, and degradation by ultraviolet rays tends to progress significantly.

The technique described in PTL 1 is insufficient in the weather resistance of asphalt pavement.

PTL 2 does not specifically disclose a composition containing an asphalt, and is not intended to increase weather resistance of asphalt pavement.

The present invention relates to a method for producing an asphalt emulsion, an asphalt emulsion, an asphalt mix for pavement, and a method for paving a road.

The present inventors have found that, by a method for producing an asphalt emulsion, the method including a step 1: a step of melt-mixing an asphalt and a polyester to obtain an asphalt mixture and a step 2: a step of adding an aqueous medium and a surfactant to the asphalt mixture obtained in the step 1, followed by mixing, degradation by ultraviolet rays is suppressed and an asphalt emulsion having an increased weather resistance can be produced.

Specifically, the present invention provides the following [1] to [4].

[1] A method for producing an asphalt emulsion, the method including the following step 1 and step 2:
step 1: a step of melt-mixing an asphalt and a polyester to obtain an asphalt mixture;
step 2: a step of adding an aqueous medium and a surfactant to the asphalt mixture obtained in the step 1, followed by mixing.
   [2] An asphalt emulsion containing composite particles, the composite particles containing an asphalt and a polyester and having
a volume median particle diameter (D₅₀) of 1 μm or more and 40 μm or less.
   [3] An asphalt mix for pavement, the asphalt mix containing the asphalt emulsion according to the above [2] and an aggregate.
   [4] A method for paving a road, the method including a step of laying the asphalt mix for pavement according to the above [3] onto a road at 150° C. or lower.

The present invention can provide a method for producing an asphalt emulsion superior in weather resistance, an asphalt emulsion, an asphalt mix for pavement, and a method for paving a road.

### [Method for Producing an Asphalt Emulsion]

The method for producing an asphalt emulsion of the present invention includes the following step 1 and step 2:
step 1: a step of melt-mixing an asphalt and a polyester to obtain an asphalt mixture;
step 2: a step of adding an aqueous medium and a surfactant to the asphalt mixture obtained in the step 1, followed by mixing.

The present invention also includes the following aspect:
a method for producing an asphalt emulsion, the method including the following step 1 and step 2:
step 1: a step of melt-mixing an asphalt and a polyester having a weight average molecular weight of 2,000 or more and 100,000 or less to obtain an asphalt mixture;
step 2: a step of adding an aqueous medium and a surfactant to the asphalt mixture obtained in the step 1, followed by mixing.

The reason why the effect of the present invention is achieved is not clear, but it has been found that an asphalt emulsion obtained by the production method of the present invention and a road surface of an asphalt produced with the asphalt emulsion have an increased weather resistance.

### [Step 1]

In the step 1, from the viewpoint of emulsifiability and weather resistance, an asphalt and a polyester are melt-mixed to obtain an asphalt mixture.

### <Asphalt>

As an asphalt to be used in the present invention, various asphalts can be used. Examples thereof include a straight asphalt which is a petroleum asphalt for pavement and a modified asphalt.

Straight asphalt refers to a residual bituminous substance obtained by subjecting crude petroleum to an atmospheric distillation apparatus, a vacuum distillation apparatus, or the like

Examples of the modified asphalt include a blown asphalt; and an asphalt modified with a polymer material, such as a thermoplastic elastomer or a thermoplastic resin.

Examples of the thermoplastic elastomer include a styrene/butadiene/block copolymer (SBS), a styrene/isoprene/block copolymer (SIS), and an ethylene/vinyl acetate copolymer (EVA).

Examples of the thermoplastic resin include an ethylene/vinyl acetate copolymer, an ethylene/ethyl acrylate copolymer, a polyethylene, and a polypropylene.

Among them, a straight asphalt is preferred.

The degree of penetration of an asphalt, in particular, a straight asphalt is, from the viewpoint of emulsifiability, preferably 40 or more, more preferably 60 or more, and further preferably 80 or more, and from the viewpoint of pavement strength after laying, is preferably 250 or less, more preferably 230 or less, and further preferably 210 or less.

The degree of penetration is a measure of hardness of an asphalt. The degree of penetration is measured by a method defined in JIS K2207:2006. Under the testing conditions described in JIS K2207:2006, the case where the length of a specified needle vertically penetrating a sample at 25° C. is 0.1 mm is taken as a degree of penetration of 1.

### <Polyester>

The polyester contains an alcohol component-derived structural unit and a carboxylic acid component-derived structural unit, and is obtained by subjecting a carboxylic acid component and an alcohol component to polycondensation reaction. Properties and the like of the alcohol component, the carboxylic acid component, and the polyester will be described below.

One polyester can be used alone or two or more polyesters can be used in combination.

The “alcohol component-derived structural unit” in the polyester, as used herein, means a structure obtained by removing a hydrogen atom from a hydroxy group of an alcohol component, and the “carboxylic acid component-derived structural unit” means a structure obtained by removing a hydroxy group from a carboxy group of a carboxylic acid component.

The “carboxylic acid component” is a concept including, not only the carboxylic acid, but also the anhydride which decomposes in a reaction to produce the acid, and an alkyl ester (in which the alkyl group has, for example, 1 or more and 3 or less carbon atoms) of the carboxylic acid. When the carboxylic acid component is an alkyl ester of the carboxylic acid, the number of carbon atoms of the alkyl group that is the alcohol residue of the ester is not included in the number of carbon atoms of the carboxylic acid component.

### (Alcohol Component)

Examples of the alcohol component include an aliphatic diol, an aromatic diol, and a trihydric or higher polyhydric alcohol. One of the alcohol components can be used alone or two or more thereof can be used in combination.

The number of carbon atoms of the aliphatic diol is, from the viewpoint of emulsifiability, preferably 4 or more, more preferably 5 or more, and further preferably 6 or more, and from the viewpoint of weather resistance, is preferably 16 or less, more preferably 12 or less, and further preferably 8 or less.

Examples of the aliphatic diol include aliphatic diols, such as ethylene glycol, 1,2-propanediol, 1,3-propanediol, 1,4-butanediol, 1,6-hexanediol, 1,7-heptanediol, 1,8-octanediol, 1,9-nonanediol, 1,10-decanediol, 1,11-undecanediol, and 1,12-dodecanediol. The aliphatic diol is preferably one or more selected from 1,4-butanediol, 1,6-hexanediol, 1,7-heptanediol, 1,8-octanediol, 1,9-nonanediol, 1,10-decanediol, 1,11-undecanediol, and 1,12-dodecanediol, and more preferably one or more selected from 1,6-hexanediol, 1,7-heptanediol, and 1,8-octanediol.

The aliphatic diol is, from the viewpoint of emulsifiability, preferably an aliphatic diol having a hydroxy group at a terminal of a carbon chain, more preferably an α,ω-aliphatic diol, and further preferably an α,ω-linear alkanediol.

Examples of the aromatic diol include bisphenol A and an alkylene oxide adduct of bisphenol A. Examples of the alkylene oxide adduct of bisphenol A include a propylene oxide adduct of 2,2-bis(4-hydroxyphenyl)propane and an ethylene oxide adduct of 2,2-bis(4-hydroxyphenyl)propane. Among them, a combination of a propylene oxide adduct of 2,2-bis(4-hydroxyphenyl)propane and an ethylene oxide adduct of 2,2-bis(4-hydroxyphenyl)propane is preferred.

An example of the trihydric or higher polyhydric alcohol includes glycerol.

From the viewpoint of weather resistance, the alcohol component preferably contains an aliphatic diol. In the alcohol component, an alcohol other than aliphatic diols may be contained, but the content of the aliphatic diol in the alcohol components is preferably 70% by mole or more, more preferably 90% by mole or more, and further preferably 95% by mole or more, and is 100% by mole or less.

In one of preferred aspects of the present invention, the alcohol component is substantially constituted only of an aliphatic diol.

The alcohol component may contain a monohydric aliphatic alcohol. The number of carbon atoms of the monohydric aliphatic alcohol is, from the viewpoint of emulsifiability, preferably 12 or more, and more preferably 14 or more, and from the viewpoint of weather resistance, is preferably 20 or less, and more preferably 18 or less.

Examples of the monohydric aliphatic alcohol include monohydric aliphatic alcohols having 12 or more and 20 or less carbon atoms, such as lauryl alcohol, myristyl alcohol, palmityl alcohol, and stearyl alcohol.

The content of the monohydric aliphatic alcohol is, in the total amount of the alcohol component and the carboxylic acid component, from the viewpoint of weather resistance, preferably 20% by mole or less, and more preferably 15% by mole or less.

### (Carboxylic Acid Component)

Examples of the carboxylic acid component include an aliphatic dicarboxylic acid, an aromatic dicarboxylic acid, and a tribasic or higher and hexabasic or lower polybasic carboxylic acid. One of the carboxylic acid components can be used alone or two or more thereof can be used in combination.

The number of carbon atoms of the aliphatic dicarboxylic acid is, from the viewpoint of emulsifiability, preferably 4 or more, more preferably 6 or more, and further preferably 8 or more, and from the viewpoint of weather resistance, is preferably 14 or less, more preferably 13 or less, and further preferably 12 or less.

The chain hydrocarbon group in the aliphatic dicarboxylic acid may be linear or branched.

Examples of the aliphatic dicarboxylic acid include aliphatic dicarboxylic acids having 4 or more and 14 or less carbon atoms, such as succinic acid, suberic acid, azelaic acid, sebacic acid, dodecanedioic acid, tetradecanedioic acid, and a succinic acid having an alkyl group or an alkenyl group as a side chain.

Examples of the aromatic dicarboxylic acid include terephthalic acid and isophthalic acid.

Examples of the trihydric or higher polybasic carboxylic acid include trimellitic acid and pyromellitic acid.

From the viewpoint of weather resistance, the carboxylic acid component preferably contains an aliphatic dicarboxylic acid. The carboxylic acid component may contain a carboxylic acid other than aliphatic dicarboxylic acids. The content of the aliphatic dicarboxylic acid in the carboxylic acid component is preferably 70% by mole or more, more preferably 90% by mole or more, and further preferably 95% by mole or more.

In one of preferred aspects of the present invention, the carboxylic acid component is substantially constituted only of an aliphatic dicarboxylic acid.

The carboxylic acid component may contain a monobasic aliphatic carboxylic acid. The number of carbon atoms of the monobasic aliphatic carboxylic acid is, from the viewpoint of emulsifiability, preferably 12 or more, and more preferably 14 or more, and from the viewpoint of weather resistance, is preferably 20 or less, and more preferably 18 or less.

Examples of the monobasic aliphatic carboxylic acid include monobasic aliphatic carboxylic acids having 12 or more and 20 or less carbon atoms, such as lauric acid, myristic acid, palmitic acid, stearic acid, and an alkyl (having 1 or more and 3 or less carbon atoms) ester of such an acid.

The content of the monobasic aliphatic carboxylic acid is, in the total amount of the alcohol component and the carboxylic acid component, from the viewpoint of weather resistance, preferably 20% by mole or less, and more preferably 15% by mole or less.

### (Preferred Aspect of Polyester)

A preferred aspect of the polyester contains
an alcohol component-derived structural unit, the alcohol component containing an am-aliphatic diol having 4 or more and 16 or less carbon atoms in an amount of preferably 70% by mole or more, more preferably 90% by mole or more, and further preferably 95% by mole or more, and
a carboxylic acid-derived structural unit, the carboxylic acid containing an aliphatic dicarboxylic acid having 4 or more and 14 or less carbon atoms in an amount of preferably 70% by mole or more, more preferably 90% by mole or more, and further preferably 95% by mole or more.

### (Composite Resin)

The polyester may be a composite resin containing a polyester segment and an addition polymerization resin segment. The composite resin preferably has a bireactive monomer-derived structural unit that is bonded to the polyester segment and the addition polymerization resin segment via a covalent bond.

The polyester segment is composed of the polyester described above.

An example of the addition polymerization resin segment is an addition polymerization product of a raw material monomer containing a styrene compound.

The “bireactive monomer-derived structural unit” means a unit obtained by a reaction of a functional group of a bireactive monomer and an addition-polymerizable group thereof. An example of the addition-polymerizable group is a carbon-carbon unsaturated bond.

An example of the styrene compound includes an unsubstituted or substituted styrene. Examples of the substituent that is substituted on styrene include an alkyl group having 1 or more and 5 or less carbon atoms, a halogen atom, an alkoxy group having 1 or more and 5 or less carbon atoms, a sulfonic acid group, and a salt thereof.

Examples of the styrene compound include styrene, methylstyrene, α-methylstyrene, β-methylstyrene, tert-butylstyrene, chlorostyrene, chloromethylstyrene, methoxystyrene, styrenesulfonic acid, and a salt thereof. Among them, styrene is preferred.

The raw material monomer of the addition polymerization product can contain a raw material monomer other than styrene compounds. Examples of the raw material monomer other than styrene compounds include (meth)acrylate esters, such as an alkyl (meth)acrylate, benzyl (meth)acrylate, and dimethylaminoethyl (meth)acrylate; olefins, such as ethylene, propylene, and butadiene; a halovinyl compound, such as vinyl chloride; vinyl esters, such as vinyl acetate and vinyl propionate; a vinyl ether, such as methyl vinyl ether; a halogenated vinylidene, such as vinylidene chloride; and an N-vinyl compound, such as N-vinylpyrrolidone. Among them, the raw material monomer other than styrene compounds is preferably a (meth)acrylate ester, and more preferably an alkyl (meth)acrylate.

The number of carbon atoms of the alkyl group in the alkyl (meth)acrylate is preferably 1 or more, more preferably 6 or more, and further preferably 8 or more, and is preferably 24 or less, more preferably 22 or less, and further preferably 20 or less.

Examples of the alkyl (meth)acrylate include methyl (meth)acrylate, ethyl (meth) acrylate, (iso)propyl (meth)acrylate, (iso or tert-)butyl (meth) acrylate, (iso)amyl (meth) acrylate, cyclohexyl (meth)acrylate, 2-ethylhexyl (meth)acrylate, (iso)octyl (meth)acrylate, (iso)decyl (meth) acrylate, (iso)dodecyl (meth)acrylate, (iso)palmityl (meth) acrylate, (iso)stearyl (meth)acrylate, and (iso)behenyl (meth)acrylate. The alkyl (meth)acrylate is preferably 2-ethylhexyl (meth)acrylate.

“(Meth)acrylic acid” represents acrylic acid or methacrylic acid. “iso or tert-)” and “(iso)” mean both the case with the prefix and the case without the prefix, and in the case without the prefix, they represent the normal ones.

Examples of the bireactive monomer include addition-polymerizable monomers having in the molecule at least one functional group selected from a hydroxy group, a carboxy group, an epoxy group, a primary amino group, and a secondary amino group. Among them, from the viewpoint of reactivity, an addition-polymerizable monomer having at least one functional group selected from a hydroxy group and a carboxy group is preferred, and an addition-polymerizable monomer having a carboxy group is more preferred.

Examples of the addition-polymerizable monomer having a carboxy group include acrylic acid, methacrylic acid, fumaric acid, and maleic acid. Among them, from the viewpoint of reactivity of the both of polycondensation reaction and addition polymerization reaction, the addition-polymerizable monomer having a carboxy group is preferably acrylic acid or methacrylic acid, and is more preferably acrylic acid.

The content of the polyester segment in the composite resin is preferably 40% by mass or more, more preferably 50% by mass or more, and further preferably 60% by mass or more, and is preferably 95% by mass or less, and more preferably 90% by mass or less.

The content of the addition polymerization resin segment in the composite resin is preferably 5% by mass or more, and more preferably 10% by mass or more, and is preferably 60% by mass or less, more preferably 50% by mass or less, and further preferably 40% by mass or less.

The content of the bireactive monomer-derived structural unit is, relative to 100% by mole of the alcohol component in the polyester segment of the composite resin, preferably 1% by mole or more, more preferably 1.5% by mole or more, and further preferably 2% by mole or more, and is preferably 30% by mole or less, more preferably 20% by mole or less, and further preferably 10% by mole or less.

The total content of the polyester segment, the addition polymerization resin segment, and the bireactive monomer-derived structural unit in the composite resin is preferably 80% by mass or more, more preferably 90% by mass or more, further preferably 95% by mass or more, and further preferably 100% by mass.

In the raw material monomer of the addition polymerization resin segment, the content of the styrene compound is preferably 50% by mass or more, more preferably 65% by mass or more, and further preferably 75% by mass or more, and is 100% by mass or less, preferably 95% by mass or less, more preferably 90% by mass or less, and further preferably 85% by mass or less.

In the raw material monomer of the addition polymerization resin segment, the content of the (meth)acrylate ester is preferably 5% by mass or more, more preferably 10% by mass or more, and further preferably 15% by mass or more, and is preferably 50% by mass or less, more preferably 35% by mass or less, and further preferably 25% by mass or less.

The total content of the styrene compound and the (meth)acrylate ester in the raw material monomer of the addition polymerization resin segment is preferably 80% by mass or more, more preferably 90% by mass or more, further preferably 95% by mass or more, and further preferably 100% by mass.

### (Molar Ratio of Carboxylic Acid Component-Derived Structural Unit to Alcohol Component-Derived Structural Unit)

The molar ratio of the carboxylic acid component-derived structural unit to the alcohol component-derived structural unit [carboxylic acid component/alcohol component] is, from the viewpoint of weather resistance, preferably 0.6 or more, more preferably 0.7 or more, and further preferably 0.8 or more, and is preferably 1.5 or less, more preferably 1.3 or less, and further preferably 1.0 or less.

### (Properties of Polyester)

The weight average molecular weight of the polyester is, from the viewpoint of weather resistance, preferably 2,000 or more, more preferably 3,000 or more, further preferably 4,000 or more, further preferably 5,000 or more, and further preferably 8,000 or more, and from the viewpoint of emulsifiability, is preferably 100,000 or less, more preferably 80,000 or less, further preferably 50,000 or less, and further preferably 35,000 or less.

The acid value of the polyester is, from the viewpoint of weather resistance, preferably 0.5 mgKOH/g or more, more preferably 1.0 mKOH/g or more, and further preferably 1.5 mgKOH/g or more, and is preferably 50 mgKOH/g or less, more preferably 30 mgKOH/g or less, and further preferably 15 mgKOH/g or less.

The hydroxyl value of the polyester is, from the viewpoint of increasing weather resistance by reactivity with a maltene component, preferably 2 mgKOH/g or more, more preferably 10 mgKOH/g or more, and further preferably 20 mgKOH/g or more, and from the viewpoint of emulsifiability, is preferably 70 mgKOH/g or less, more preferably 50 mgKOH/g or less, and further preferably 40 mgKOH/g or less.

The softening point of the polyester is, from the viewpoint of weather resistance, preferably 40° C. or higher, more preferably 50° C. or higher, and further preferably 60° C. or higher, and from the viewpoint of emulsifiability, is preferably 130° C. or lower, more preferably 110° C. or lower, and further preferably 90° C. or lower.

When the polyester has a glass transition point, from the viewpoint of weather resistance, the glass transition point is preferably 40° C. or higher, more preferably 45° C. or higher, and further preferably 50° C. or higher, and from the viewpoint of emulsifiability, is preferably 80° C. or lower, more preferably 75° C. or lower, and further preferably 70° C. or lower.

When the polyester has an endothermic maximum peak temperature, from the viewpoint of weather resistance, the endothermic maximum peak temperature is preferably 50° C. or higher, and preferably 60° C. or higher, and from the viewpoint of emulsifiability, is 150° C. or lower.

The weight average molecular weight, the acid value, the hydroxyl value, the softening point, and the glass transition point of the polyester can be measured by methods described in Examples. The weight average molecular weight, the acid value, the hydroxyl value, the softening point, and the glass transition point can be adjusted by the raw material monomer composition, the molecular weight, the amount of catalyst, the reaction conditions or the like.

The solubility parameter (SP value) of the polyester is, from the viewpoint of weather resistance, preferably 8 or more, more preferably 8.5 (cal/cm³)^{1/2} or more, and further preferably 9 (cal/cm³)^{1/2} or more, and from the viewpoint of emulsifiability, is preferably 12 (cal/cm³)^{1/2} or less, more preferably 11 (cal/cm³)^{1/2} or less, and further preferably 10 (cal/cm³)^{1/2} or less.

The SP value in this description is determined using a calculation method described in “Specific Interactions and the Miscibility of Polymer Blends” (1991) (Technomic Publishing Co. Inc.) by Michael M. Coleman, John F. Graf, Paul C. Painter (Pennsylvania State Univ.).

### (Method for Producing Polyester)

The method for producing the polyester is not particularly limited, but, for example, the polyester can be produced by polycondensation of the alcohol component and the carboxylic acid component described above.

The amounts of the alcohol component and the carboxylic acid blended are such amounts that give a molar ratio of the carboxylic acid component-derived structural unit to the alcohol component-derived structural unit [carboxylic acid component/alcohol component] within the above numerical range.

The temperature of the polycondensation reaction is, from the viewpoint of reactivity, preferably 160° C. or higher, more preferably 180° C. or higher, and further preferably 190° C. or higher, and is preferably 260° C. or lower, more preferably 250° C. or lower, and further preferably 240° C. or lower.

In the polycondensation reaction, from the viewpoint of reaction rate, an esterification catalyst can be used. An example of the esterification catalyst is a tin(II) compound having no Sn—C bond, such as tin(II) cli(2-ethylhexanoate). The amount of the esterification catalyst used is, from the viewpoint of reaction rate, relative to 100 parts by mass of the total amount of the alcohol component and the carboxylic acid component, preferably 0.01 part by mass or more, more preferably 0.1 part by mass or more, and further preferably 0.2 parts by mass or more, and is preferably 1.5 parts by mass or less, more preferably 1.0 parts by mass or less, and further preferably 0.6 parts by mass or less.

In the polycondensation reaction, in addition to the esterification catalyst, a co-catalyst can be used. An example of the co-catalyst is a pyrogallol compound, such as gallic acid. The amount of the co-catalyst used is, relative to 100 parts by mass of the total amount of the alcohol component and the carboxylic acid component, preferably 0.001 part by mass or more, more preferably 0.005 parts by mass or more, and further preferably 0.01 part by mass or more, and is preferably 0.15 parts by mass or less, more preferably 0.10 parts by mass or less, and further preferably 0.05 parts by mass or less.

When the polyester is a composite resin, for example, the composite resin can be produced by a method including a step A of subjecting an alcohol component and a carboxylic acid component of a polyester segment to polycondensation and a step B of subjecting a raw material monomer of an addition polymerization resin segment and a bireactive monomer to addition polymerization.

The step B may be performed after the step A, the step A may be performed after the step B, or the step A and the step B may be simultaneously performed.

The temperature of the addition polymerization in the step B is preferably 110° C. or higher and more preferably 130° C. or higher, and is preferably 230° C. or lower, more preferably 220° C. or lower, and further preferably 210° C. or lower.

In the addition polymerization, a radical polymerization initiator can be used. Examples of the radical polymerization initiator include a peroxide, such as dibutyl peroxide, a persulfate, such as sodium persulfate, and an azo compound, such as 2,2′-azobis(2,4-dimethylvaleronitrile). The amount of the radical polymerization initiator used is, relative to 100 parts by mass of the raw material monomer of the addition polymerization resin segment, preferably 1 part by mass or more and 20 parts by mass or less.

The amount of the polyester used in the step 1 is, from the viewpoint of weather resistance, relative to 100 parts by mass of the asphalt, preferably 1 part by mass or more, more preferably 2 parts by mass or more, and further preferably 3 parts by mass or more, and is preferably 50 parts by mass or less, more preferably 30 parts by mass or less, and further preferably 20 parts by mass or less.

The time of the melt-mixing in the step 1 is, from the viewpoint of weather resistance, preferably 5 minutes or more, more preferably 10 minutes or more, further preferably 20 minutes or more, and further preferably 30 minutes or more, and from the viewpoint of emulsifiability, is preferably 5 hours or less, more preferably 4 hours or less, further preferably 3 hours or less, and further preferably 2 hours or less.

The temperature in the melt-mixing is, from the viewpoint of weather resistance, preferably 130° C. or higher, more preferably 140° C. or higher, and further preferably 150° C. or higher, and from the viewpoint of emulsifiability, is preferably 220° C. or lower, more preferably 210° C. or lower, and further preferably 200° C. or lower.

The stirrer for melt-mixing is not particularly limited, and an ordinary anchor-type impeller or a propeller-type impeller can be used. The rate of stirring is preferably 50 rpm or more, more preferably 100 rpm or more, and further preferably 150 rpm or more, and is preferably 500 rpm or less, more preferably 450 rpm or less, and further preferably 400 rpm or less. From the viewpoint of emulsifiability, a high-speed shearing machine, such as a homomixer, may be used. The rate of stirring of the high-speed shearing machine is preferably 3,000 rpm or more, more preferably 4,000 rpm or more, and further preferably 5,000 rpm or more, and is preferably 15,000 rpm or less, more preferably 12,000 rpm or less, and further preferably 10,000 rpm or less.

Thus, an asphalt mixture is obtained.

In the obtained asphalt mixture, a polyester is dispersed in an asphalt. The average polyester dispersion diameter in the asphalt is, from the viewpoint of weather resistance, preferably 0.1 μm or more, more preferably 0.5 μm or more, and further preferably 1 μm or more, and is preferably 20 μm or less, more preferably 10 μm or less, further preferably 5 μm or less.

The average polyester dispersion diameter in the asphalt can be measured by a method described in Examples.

### [Step 2]

In the step 2, an aqueous medium and a surfactant are added to the asphalt mixture obtained in the step 1, followed by mixing.

### (Aqueous Medium)

The aqueous medium is a dispersion medium in which water occupies the maximum proportion by mass. The water content in the aqueous medium is, from the viewpoint of weather resistance, preferably 80% by mass or more, more preferably 90% by mass or more, and further preferably 95% by mass or more, and is 100% by mass or less.

Examples of a component other than water include organic solvents that are soluble in water, for example, alkyl alcohols having 1 or more and 5 or less carbon atoms, such as methanol and ethanol; dialkyl ketones having 3 or more and 5 or less carbon atoms, such as acetone and methyl ethyl ketone; and a cyclic ether, such as tetrahydrofuran.

In one of preferred aspects of the present invention, the aqueous medium is substantially constituted only of water.

The solid content in the obtained asphalt emulsion is, from the viewpoint of weather resistance, preferably 20% by mass or more, more preferably 30% by mass or more, and further preferably 40% by mass or more, and from the viewpoint of emulsifiability, is preferably 80% by mass or less, more preferably 75% by mass or less, and further preferably 70% by mass or less. An aqueous medium in such an amount that gives a solid content of the asphalt emulsion in the above range is preferably added.

### (Surfactant)

Examples of the surfactant include a cationic surfactant, an anionic surfactant, an amphoteric surfactant, and a nonionic surfactant. From the viewpoint of emulsifiability, the surfactant is preferably a cationic surfactant.

As the cationic surfactant, a mineral acid salt, a lower carboxylic acid salt, or a quaternary ammonium salt of an amine, such as an alkyl amine, an alkyl polyamine, an amide amine, or an alkyl imidazoline, can be exemplified.

Into the cationic surfactant, in terms of the form of the surfactant, for example, for the purpose of making the surfactant into a liquid form, a solvent, such as water, a lower alcohol, glycol, or polyoxyethylene glycol, a saccharide, such as glucose or sorbitol, a lower fatty acid, a lower amine, or a hydrotropic agent, such as p-toluenesulfonic acid or an ether carboxylic acid, can be blended.

The content of the cationic surfactant is, in view of the economy, from the viewpoint of superior storage stability, based on the total mass of the obtained asphalt emulsion, preferably 0.02% by mass or more, more preferably 0.05% by mass or more, and further preferably 0.10% by mass or more, and is preferably 3.0% by mass or less, more preferably 2.0% by mass or less, and further preferably 1.0% by mass or less.

### (Inorganic Salt)

In the step 2, from the viewpoint of emulsifiability, an inorganic salt can further be added and mixed. Examples of the inorganic salt include sodium chloride, potassium chloride, calcium chloride, and aluminum chloride. The inorganic salt is preferably calcium chloride.

The content of the inorganic salt is, based on the total mass of the obtained asphalt emulsion, preferably 0.01% by mass or more, more preferably 0.03% by mass or more, and further preferably 0.05% by mass or more, and is preferably 3.0% by mass or less, more preferably 2.0% by mass or less, and further preferably 1.0% by mass or less.

From the viewpoint of emulsifiability, the addition and mixing in the step 2 is preferably performed with an emulsifier, such as a colloid mill, a Hurrell-type homogenizer, a homogenizer, or a line mixer.

From the viewpoint of emulsifiability, the asphalt mixture obtained in the step 1 is preferably subjected to addition and mixing in the step 2 in a melt-state at preferably 120° C. or higher, more preferably 125° C. or higher, and further preferably 130° C. or higher, and preferably 160° C. or lower, more preferably 155° C. or lower, and further preferably 150° C. or lower.

The aqueous medium and the surfactant are preferably mixed in advance. From the viewpoint of emulsifiability, the aqueous medium and the surfactant are preferably subjected to addition and mixing in the step 2 at preferably 30° C. or higher, more preferably 35° C. or higher, and further preferably 40° C. or higher, and preferably 60° C. or lower, and more preferably 55° C. or lower.

### <Asphalt Emulsion>

Thus, the asphalt emulsion is obtained.

An asphalt emulsion is generally an emulsion in which particles of an asphalt are stably dispersed in water using a surfactant.

The present invention also relates to an asphalt emulsion that can be obtained by the above production method.

The asphalt emulsion of the present invention contains composite particles, the composite particles containing an asphalt and a polyester and having a volume median particle diameter (D50) of 1 μm or more and 40 μm or less. The asphalt emulsion is preferably a dispersion of the composite particles in water, and the composite particles are preferably composite particles in which the polyester described above is dispersed in the asphalt described above.

The present invention includes the following aspect:
an asphalt emulsion containing an asphalt and a polyester having a weight average molecular weight of 2,000 or more and 100,000 or less.

### (Volume Median Particle Diameter (D₅₀) and Particle Diameter Distribution)

The volume median particle diameter (D₅₀) of the composite particles which constitute the asphalt emulsion is, from the viewpoint of weather resistance, 1 μm or more and 40 μm or less, and is preferably 2 μm or more, more preferably 5 μm or more, and further preferably 10 μm or more, and is preferably 30 μm or less, more preferably 25 μm or less, and further preferably 20 μm or less.

The volume median particle diameter (D₅₀) as used herein means a particle diameter that gives a cumulative volume frequency of 50% as calculated from the smaller particle diameter side on the basis of the volume fraction. The volume median particle diameter (D₅₀) can be determined by a method described in Examples given later.

From the viewpoint of weather resistance, the composite particles which constitute the asphalt emulsion have a particle diameter distribution in which the particle frequency of 500 nm or less is preferably 5% by volume or less, more preferably 2% by volume or less, further preferably 1% by volume or less, and further preferably 0.5% by volume or less.

The particle diameter distribution can be determined by a method described in Examples given later.

### (Content of Asphalt)

The content of the asphalt in the composite particles which constitute the asphalt emulsion is, from the viewpoint of weather resistance, preferably 50% by mass or more, more preferably 75% by mass or more, and further preferably 90% by mass or more, and preferably 99% by mass or less, and more preferably 98% by mass or less.

### (Content of Polyester)

The content of the polyester in the composite particles which constitute the asphalt emulsion is, from the viewpoint of weather resistance, relative to 100 parts by mass of the asphalt, preferably 1 part by mass or more, more preferably 2 parts by mass or more, and further preferably 3 parts by mass or more, and is preferably 50 parts by mass or less, more preferably 30 parts by mass or less, and further preferably 20 parts by mass or less.

### (Solid Content)

The solid content of the asphalt emulsion is, from the viewpoint of weather resistance, preferably 20% by mass or more, more preferably 30% by mass or more, and further preferably 40% by mass or more, and from the viewpoint of emulsifiability, is preferably 80% by mass or less, more preferably 75% by mass or less, and further preferably 70% by mass or less.

The asphalt emulsion of the present invention can be used alone or with another additive or the like mixed therewith. For example, as with a known asphalt emulsion, the asphalt emulsion of the present invention can be suitably used alone for prime coat, tack coat, or the like. Alternatively, the asphalt emulsion can be suitably used with an aggregate, a filler, or the like mixed therewith for producing an asphalt mix for pavement.

Since an asphalt is dispersed in a non-heated state in the asphalt emulsion of the present invention, the asphalt emulsion can be preferably used even in a non-heated state at preferably 150° C. or lower, more preferably 100° C. or lower, further preferably 50° C. or lower. Thus, the asphalt emulsion can be suitably used for normal temperature pavement of an asphalt.

### [Asphalt Mix for Pavement]

The asphalt mix for pavement of the present invention contains the asphalt emulsion described above and an aggregate.

As the aggregate, any of crushed stones, cobble stones, gravel, sand, reclaimed aggregate, a ceramic, and the like can be freely selected and used.

The content of the aggregate is, relative to 100 parts by mass of the composite particles, preferably 1,000 parts by mass or more, more preferably 1,200 parts by mass or more, and more preferably 1,500 parts by mass or more, and is preferably 3,000 parts by mass or less, more preferably 2,500 parts by mass or less, and further preferably 2,000 parts by mass or less.

Since an asphalt is dispersed in a non-heated state in the asphalt mix for pavement of the present invention, the asphalt mix is produced by mixing the composite particles described above and an aggregate in a non-heated state at preferably 150° C. or lower, more preferably 100° C. or lower, and further preferably 50° C. or lower.

### [Method for Paving Road]

The asphalt mix for pavement of the present invention can be suitably used for laying asphalt pavement onto a road.

The method for paving a road of the present invention has a step of laying the mixture for paving described above onto a road to form an asphalt pavement material layer. The asphalt pavement material layer may be either of a base course or a surface course.

The asphalt mix for pavement of the present invention can be suitably used for normal temperature pavement. Specifically, the temperature in laying is preferably 150° C. or lower, more preferably 100° C. or lower, and further preferably 50° C. or lower in a non-heated state.

### EXAMPLES

In the following Preparation Examples, Production Examples, Examples, and Comparative Example, “parts” and “%” mean “parts by mass” and “% by mass” unless otherwise specified.

(1) Method of measuring acid value and hydroxyl value of polyester

The acid value and the hydroxyl value of the polyester were measured based on the method of JIS K0070:1992. However, only the measurement solvent was changed from a mixed solvent of ethanol and ether defined in JIS K0070:1992 to a mixed solvent of acetone and toluene (acetone:toluene=1:1 (by volume)) for polyesters (A1) and (A2), and to a mixed solvent of chloroform and dimethylformamide (chloroform:dimethylformamide=7:3 (by volume)) for polyester (A3).

(2) Method of measuring softening point, endothermic maximum peak temperature, and glass transition point of polyester
(i) Softening point

Using a flow tester (“CFT-500D” manufactured by SHIMADZU CORPORATION), a load of 1.96 MPa was applied with a plunger to 1 g of a sample while heating the sample at a temperature rise rate of 6° C./minute to extrude the sample from a nozzle having a diameter of 1 mm and a length of 1 mm. The amount of lowering of the plunger of the flow tester was plotted relative to the temperature, and the temperature at which the half amount of the sample had flowed out was taken as the softening point.

(ii) Endothermic maximum peak temperature and glass transition point

Using a differential scanning calorimeter (“Q-100” manufactured by TA Instruments Japan Inc.), 0.01 to 0.02 g of a sample was weighed into an aluminum pan, was heated to 200° C., and was then cooled from the temperature to 0° C. at a temperature lowering rate of 10° C./minute. Next, while increasing the temperature to 150° C. at a temperature rise rate of 10° C./min, the calory was measured.

The temperature of a peak having the largest peak area, among the observed endothermic peaks, was taken as the endothermic maximum peak temperature. When no peak was observed but a step was observed, the temperature at which the tangential line having the maximum inclination of a curve in a step portion was intersected with the extension of the baseline on the lower temperature side of the step was read as the glass transition point.

(3) Method of measuring weight average molecular weight of polyester

The molecular weight distribution was measured by gel permeation chromatography (GPC) method obtained by the following method to determine the weight average molecular weight.

(i) Preparation of sample solution

A sample was dissolved in a solvent at 25° C. so as to give a concentration of 0.5 g/100 mL. Next, this solution was filtered with a fluororesin filter having a pore size of 0.2 μm (“DISMIC-25JP” manufactured by TOYO ROSHI KAISHA, LTD.) to remove insoluble matter, thus preparing a sample solution.

As a solvent, chloroform was used for the polyesters (A1) and (A2), and tetrahydrofuran was used for the polyester (A3).

(ii) Measurement of molecular weight

Using the following measurement apparatus and analytical columns, the same solvent as that used in preparation of the sample solution was allowed to flow as an eluent at a flow rate of 1 mL per minute, and the columns were stabilized in a thermostatic chamber of 40° C. A sample solution 100 μL was injected therein to perform measurement. The molecular weight of the sample was calculated based on a previously created calibration curve. Here, as the calibration curve, one created using several monodispersed polystyrenes “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97×10⁴), “F-10” (9.64×10⁴), “F-20” (1.90×10⁵), “F-40” (4.27×10⁵), “F-80” (7.06×10⁵), and “F-128” (1.09×10⁶) (all manufactured by TOSOH CORPORATION) as standard samples was used.

Measurement apparatus: “HLC-8220CPC” (manufactured by TOSOH CORPORATION)

Analytical columns: “GMHXL” +“G3000HXL” (manufactured by TOSOH CORPORATION)

(4) Method of measuring polyester dispersion diameter in asphalt mixture

A melt-mixed asphalt mixture was added dropwise onto a microscope slide, was covered with a cover glass, and then, was heated at 120° C. for 1 minute to produce a measurement sample as a thin layer. The measurement sample was observed with a digital microscope (“VHX-1000” manufactured by KEYENCE CORPORATION), and the diameters of 30 polyester particles randomly selected from the microscopic field were measured by image analysis and the average thereof was taken as the polyester dispersion diameter.

(5) Method of measuring volume median particle diameter (D₅₀) and particle diameter distribution of asphalt emulsion
(i) Measurement apparatus: laser diffraction particle size analyzer “LA-920” (manufactured by HORIBA, Ltd.)
(ii) Measurement conditions: distilled water was added to an asphalt emulsion to adjust the concentration so that the particle diameters of 30,000 particles could be measured in 20 seconds. Then, 30,000 particles were measured to obtain a particle diameter distribution. From the obtained particle diameter distribution, the volume median particle diameter (D₅₀) and the particle frequency of particle diameters of 500 nm or less were determined.

### Synthetic Examples 1 to 2 (Synthesis of Polyesters (A1) to (A2))

1,6-Hexanediol and sebacic acid shown in Table 1 were placed in a 5-liter four-neck flask equipped with a thermometer, a stainless steel stirring rod, a flow-down condenser, and a nitrogen introducing tube, 20 g of tin(II) di(2-ethylhexanoate) was added thereto in a nitrogen atmosphere. The mixture was heated in a mantle heater from 140° C. to 200° C. over 7 hours, and after 200° C. was reached, a reaction was performed at a reduced pressure at 8.0 kPa until the softening point shown in Table 1 was reached, thereby obtaining a target polyesters (A1) to (A2). The results are shown in Table 1.

### Synthetic Example 3 (Synthesis of Polyester (A3))

A polyoxypropylene adduct of bisphenol, a polyoxyethylene adduct of bisphenol, terephthalic acid, and dodecenylsuccinic anhydride shown in Table 1 were placed in a 5-liter four-neck flask equipped with a stainless-steel stirring rod, a flow-down condenser, and a nitrogen introducing tube, and were heated to 160° C. in a mantle heater in a nitrogen atmosphere. A mixture of styrene, 2-ethylhexyl acrylate, acrylic acid, and dibutylperoxide was added dropwise thereto to perform polymerization.

Then, 20 g of tin(II) di(2-ethylhexanoate) and 2 g of gallic acid were added thereto, and the temperature was increased to 235° C. over 3 hours, and after 235° C. was reached, the temperature was kept for 5 hours. Then, a reaction was performed under a reduced pressure of 8.0 kPa for 1 hour, followed by cooling to 210° C. Trimellitic anhydride was put therein at 210° C., and the mixture was kept at 210° C. for 1 hour. A reaction was performed under a reduced pressure of 8.0 kPa, and was continued until the temperature reached the softening point shown in Table 1, thereby obtaining a polyester (A3) which was a composite resin. The results are shown in Table 1.

TABLE 1

| | | | Synthetic Example | | | | | |
|---|---|---|---|---|---|---|---|---|
| | | | 1 | | 2 | | 3 | |
| Type of polyester | | | A1 | | A2 | | A3 | |
| | | | Charged | Molar | Charged | Molar | Charged | Molar |
| | | | amount | ratio | amount | ratio | amount | ratio |
| | Monomer composition | | (g) | *3 | (g) | *3 | (g) | *3 |
| Raw | Alcohol | 1,6-Hexanediol | 1523 | 100 | 1430 | 100 | | |
| material | component | BPA-PO *1 | | | | | 1614 | 70 |
| monomer | | BPA-EO *2 | | | | | 642 | 30 |
| | Carboxylic acid | Sebacic acid | 2477 | 95 | 2570 | 105 | | |
| | component | Dodecenylsuccinic | | | | | 304 | 18 |
| | | anhydride | | | | | | |
| | | Terephthalic acid | | | | | 547 | 50 |
| | | Trimellitic anhydride | | | | | 278 | 22 |
| | Carboxylic acid- | Acrylic acid | | | | | 14 | 3 |
| | type bireactive | | | | | | | |
| | monomer | | | | | | | |
| | | | | | | | Charged | Mass |
| | | | | | | | amount | ratio |
| | | | | | | | (g) | *4 |
| | Addition | Styrene | | | | | 436 | 84 |
| | polymerization- | | | | | | | |
| | type monomer | 2-Ethylhexyl acrylate | | | | | 83 | 16 |
| | Initiator | Dibutyl peroxide | | | | | 39 | 7.5 |

| | | | | |
|---|---|---|---|---|
| Properties | Solubility parameter | 9.83 | 9.86 | 10.74 |
| | (SP value) (cal/cm³)^{1/2} | | | |
| | Softening point (° C.) | 67.9 | 68.8 | 110.0 |
| | Acid value (mgKOH/g) | 2.0 | 25.4 | 26.0 |
| | hydroxyl value (mgKOH/g) | 25.8 | 2.4 | 25.0 |
| | Glass transition point (° C.) | — | — | 58.0 |
| | Endothermic maximum | 66.8 | 67.0 | — |
| | peak temperature (° C.) | | | |
| | Weight average molecular weight | 11035 | 12405 | 32084 |

*1: BPA-PO: polyoxypropylene (2.2 mol) adduct of bisphenol A
*2: BPA-EO: polyoxyethylene (2.2 mol) adduct of bisphenol A
*3: Moles relative to 100 moles of alcohol components (molar ratio)
*4: Mass relative to 100 parts by mass of total amount of addition polymerization-type monomers (parts by mass)

### Production Example 1 (Production of Asphalt Mixture (AS1))

As a binder mixture, 1,560 g of a straight asphalt (manufactured by COSMO OIL Co., Ltd., degree of penetration 150-200) heated to 180° C. was placed in a 3-liter stainless-steel container, and 78 g (5 parts by mass relative to 100 parts by mass of the asphalt) of the polyester (A1) obtained in Synthetic Example 1 was added thereto little by little. The mixture was stirred with an anchor-type impeller at 300 rpm at 180° C. for 1 hour to produce an asphalt mixture (AS1).

The polyester dispersion diameter in the asphalt mixture was measured to confirm that the polyester was dispersed in the asphalt. The results are shown in Table 2.

### Production Examples 2 to 5 and Comparative Production Example 1

Asphalt mixtures (AS2) to (AS6) were obtained in the same manner as in Production Example 1 except for changing the conditions in Production Example 1 to conditions shown in Table 2.

TABLE 2

| | | | | Production | | |
|---|---|---|---|---|---|---|
| | | Polyester | | conditions | | Poly- |
| | | | Con- | Mix- | | |
| | | | tent | ing | | ester |
| | | | (parts | tem- | Mix- | dis- |
| | | | by | per- | ing | persion |
| | Asphalt | | mass) | ature | time | diameter |
| | mixture | Type | *1 | (° C.) | (min) | (μm) |
| Production Example 1 | AS1 | A1 | 5 | 180 | 60 | 1.9 |
| Production Example 2 | AS2 | A2 | 5 | 180 | 60 | 3.8 |
| Production Example 3 | AS3 | A3 | 5 | 180 | 60 | 8.4 |
| Production Example 4 | AS4 | A1 | 5 | 180 | 15 | 4.7 |
| Production Example 5 | AS5 | A1 | 5 | 180 | 180 | 6.5 |
| Comparative | AS6 | — | — | — | — | — |
| Production | | | | | | |
| Example 1 | | | | | | |

*1: Content of polyester relative to 100 parts by mass of asphalt (parts by mass)

### Example 1 (Production of Asphalt Emulsion (AE1))

As an aqueous phase, 7.2 g (0.3% by mass relative to theoretical yield) of a cationic surfactant (“ASFIER N100L” manufactured by Quimi-Kao S.A. de C.V.; amine mixture), 780 g of ion exchange water, and 2.4 g (0.1% by mass relative to theoretical yield) of calcium chloride were mixed, the mixture was adjusted to pH2.0 with 1.0 M hydrochloric acid, and the total weight of the aqueous phase was adjusted to 840 g with ion exchange water. Into a colloid mill, 840 g of the aqueous phase heated to 50° C. and 1,560 g of the asphalt mixture (AS1) obtained in Production Example 1 heated to 140° C. were simultaneously put to obtain an asphalt emulsion (AE1). The volume median particle diameter (D₅₀) and the particle diameter distribution of the asphalt emulsion were measured. The results are shown in Table 3.

### Examples 2 to 5 and Comparative Example 1

Asphalt emulsions (AE2) to (AE6) were obtained in the same manner as in Example 1 except for changing the conditions in Example 1 to conditions shown in Table 3. The results are shown in Table 3.

### [Evaluation of Weather Resistance]

The asphalt emulsions (AE1) to (AE6) obtained in Examples and Comparative Example were used to evaluate the weather resistance according to the following method. The results are shown in Table 3.

### (Preparation of Sample for Evaluating Weather Resistance)

Each asphalt emulsion was placed on a disposable dish (“EMS/TEK500/600” manufactured by Anton Paar GmbH) in an amount of 3 g in terms of the solid, was evenly spread, and then, was dried in a high temperature drier at 60° C. for 3 days to obtain a sample for evaluating weather resistance.

### (Accelerated Test of Degradation by UV Irradiation)

The obtained sample for evaluating weather resistance was allowed to stand in a super accelerated weathering tester (“Super Xenon Weather Meter SX75” manufactured by Suga Test Instruments Co., Ltd.), and scanning was performed at a UV intensity of 120 W/m², an irradiation wavelength of 300 to 400 nm, a temperature in tank of 40° C., a humidity of 75%, a panel temperature of 65° C., and an irradiation time of 100 h, thereby performing an accelerated test of degradation by UV irradiation.

### (Measurement of Tans Before and After UV Irradiation)

For a sample before and after UV irradiation, a kinetic viscoelasticity was measured using a rotational rheometer (“MCR301” manufactured by Anton Paar GmbH).

Using a dedicated jig (“P-PTD200/62” manufactured by Anton Paar GmbH), 1 g of the weather resistance sample heated to 120° C. was placed to a disposable dish (“EMS/TEK500/600” manufactured by Anton Paar GmbH) fixed to the rheometer, and using a 25-mm disposable plane plate (“PP25” manufactured by Anton Paar GmbH), a kinetic viscoelasticity was measured at a gap of 1.0 mm, a strain of 0.1%, and a frequency of 1.0 Hz. A temperature control unit under the sample was used for controlling the temperature, and while cooling the sample from 120° C. to 0° C. at a temperature lowering rate of 5° C./minute, tans at 20° C. was measured.

The rate of change in tans was determined according to the following formula to evaluate the weather resistance. A rate of change closer to 100% indicates a smaller degree of degradation by ultraviolet ray irradiation and a more superior weather resistance. The test results are shown in Table 3.

Rate of change in tanδ=[(tanδ after UV irradiation)/(tanδ before UV irradiation)]×100

TABLE 3

| | | | | | Evaluation of | | |
|---|---|---|---|---|---|---|---|
| | | | Particle diameter | | weather resistance | | |
| | | | | 500 nm or less | tanδ | tanδ | Rate of |
| | | | | particle | before | after | change |
| | Asphalt | Asphalt | D₅₀ | frequency | UV | UV | in tanδ |
| | emulsion | mixture | (μm) | (% by volume) | irradiation | irradiation | *1 |
| Example 1 | AE1 | AS1 | 13 | 0 | 3.36 | 3.26 | 97.0 |
| Example 2 | AE2 | AS2 | 15 | 0 | 3.25 | 3.08 | 94.8 |
| Example 3 | AE3 | AS3 | 26 | 0 | 3.41 | 2.34 | 68.6 |
| Example 4 | AE4 | AS4 | 30 | 0 | 3.38 | 2.95 | 87.3 |
| Example 5 | AE5 | AS5 | 28 | 0 | 3.16 | 2.56 | 81.0 |
| Comparative Example 1 | AE6 | AS6 | 11 | 0 | 3.64 | 1.13 | 31.0 |

*1: (tanδ after irradiation/tanδ before irradiation) ×100

It is found from Table 3 that the asphalt emulsions obtained in Examples 1 to 5 are superior in weather resistance. Since the asphalt emulsion of the present invention is superior in weather resistance, suppression in generation of cracking can be expected.

1. A method for producing an asphalt emulsion, the method comprising:
melt-mixing an asphalt and a polyester to obtain an asphalt mixture; and
adding an aqueous medium and a surfactant to the asphalt mixture, followed by mixing,
wherein the polyester has an endothermic maximum peak temperature, the endothermic maximum peak temperature being 50° C. or higher and 150° C. or lower, and
an average polyester dispersion diameter in the asphalt is 0.1 μm or more and 5 μm or less.

2. The method for producing an asphalt emulsion according to claim wherein the polyester has a solubility parameter (SP value) of 12 (cal/cm³)^{1/2} or less.

3. The method for producing an asphalt emulsion according to claim 1, wherein the polyester comprises:
an alcohol component-derived structural unit, the alcohol component containing an α,ω-aliphatic diol having 4 or more and 16 or less carbon atoms in an amount of 70% by mole or more, and
a carboxylic acid component-derived structural unit, the carboxylic acid component containing an aliphatic dicarboxylic acid having 4 or more and 14 or less carbon atoms in an amount of 70% by mole or more.

4. The method for producing an asphalt emulsion according to claim 1, wherein the melt-mixing is performed at a temperature of 130° C. or higher and 220° C. or lower.

5. The method for producing an asphalt emulsion according to claim 1, wherein the polyester has a weight average molecular weight of 2,000 or more and 100,000 or less.

6. The method for producing an asphalt emulsion according to claim 1, wherein the polyester has a softening point of 40° C. or higher and 90° C. or lower.

7. An asphalt emulsion comprising composite particles, wherein:
the composite particles comprise an asphalt and a polyester, have a volume median particle diameter (D₅₀) of 1 μm or more and 40 μm or less, the polyester is dispersed in the asphalt, and
the average polyester dispersion diameter in the asphalt is 0.1 μm or more and 5 μm or less.

8. The asphalt emulsion according to claim 7, wherein in a particle diameter distribution, a particle frequency of 500 nm or less is 5% by volume or less.

9. The asphalt emulsion according to claim 7, wherein the polyester has a solubility parameter (SP value) of 12 (cal/cm³)^{1/2} or less.

10. The asphalt emulsion according to claim 7, wherein the composite particles contain the asphalt in an amount of 50% by mass or more and 99% by mass or less.

11. The asphalt emulsion according to claim 7, wherein the composite particles contain the polyester in an amount of 1% by mass or more and 50% by mass or less.

12. The asphalt emulsion according to claim 7, wherein the asphalt emulsion has a solid content of 20% by mass or more and 80% by mass or less.

13. The asphalt emulsion according to claim 7, wherein the polyester comprises:
an alcohol component-derived structural unit, the alcohol component containing an am-aliphatic diol having 4 or more and 16 or less carbon atoms in an amount of 70% by mole or more, and
a carboxylic acid component-derived structural unit, the carboxylic acid component containing an aliphatic dicarboxylic acid having 4 or more and 14 or less carbon atoms in an amount of 70% by mole or more.

14. An asphalt mix for pavement, the asphalt mix comprising the asphalt emulsion according to claim 7 and an aggregate.

15. A method for paving a road, the method comprising laying the asphalt mix for pavement according to claim 14 onto a road at 150° C. or lower.

16. The asphalt emulsion according to claim 7, wherein the polyester has a weight average molecular weight of 2,000 or more and 100,000 or less.

17. The asphalt emulsion according to claim 7, wherein the polyester has a softening point of 40° C. or higher and 90° C. or lower.

18. The asphalt emulsion according to claim 7, wherein the polyester has an endothermic maximum peak temperature, the endothermic maximum peak temperature being 50° C. or higher and 150° C. or lower.

19. An asphalt emulsion comprising composite particles,
wherein the composite particles comprise an asphalt and a polyester and have a volume median particle diameter (D₅₀) of 1 μm or more and 40 μm or less, and
the polyester has an endothermic maximum peak temperature, the endothermic maximum peak temperature being 50° C. or higher and 150° C. or lower.

20. The asphalt emulsion according to claim 19, wherein the polyester has a softening point of 40° C. or higher and 90° C. or lower.
